(19) United States
(12) Patent Application Publication
(10) Pub. No.: US 2010/0186466 A1
(43) Pub. Date: Jul. 29, 2010

(54) TROLLING MOTOR LOCK ASSEMBLY

(76) Inventor: Donald R. Frantz, New Berlin, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 11/916,286

(22) PCT Filed: Jun. 2, 2005
(86) PCT No.: PCT/US05/19215

§ 371 Date: Dec. 3, 2007

(51) Int. Cl. E05B 65/12

(52) U.S. Cl. 70/174

(57) ABSTRACT

A trolling motor lock assembly (10) has base member (40) that is attached via a hinge (70) to a cover member (20). The base member (40) and the cover member (20), when rotated such that the cover member (20) engages the base member (40), overlay the head portion (8) of the clamping screws (18) of the motor support (6) of the trolling motor (4) preventing rotation of them. The base member (40) and the cover member (20) have cooperating cut-outs (31, 33, 35, 51, 53, 55) adjacent side-walls (25, 45) that allow the shaft of the clamping screws (18) to protrude through the cut-outs (31, 33, 35, 51, 53, 55). In that way, the base member (40) and the cover member (20) may be “clamped” down over the head portions (8) of the clamping screws (18). The base member (40) and the cover member (20) also include a cooperating catch (67) and cylinder lock (62) with a rotatable latch (65), respectively, whereby the base member (40) and the cover member (20) may be locked together to secure the head portions (8) of the clamping screws (18) between them.

### FIELD OF THE INVENTION

The present invention relates generally to locks and to other security devices that use locks and locking mechanisms. More specifically, it relates to an assembly that is used to secure a trolling motor to the transom of a boat. It also relates to such a trolling motor lock assembly that is unitary in construction such that the assembly is easy to use and eliminates the risk of loss of component parts.

### BACKGROUND OF THE INVENTION

Trolling motors are the smaller cousin to the boat outboard motor and are used in situations where a smaller powered motor is needed to achieve more incremental and much quieter movement of the boat during fishing and the like. Like outboard motors, the use of a trolling motor typically requires that the motor be attached to the transom, or rear wall, of the boat. From that position, the user can move and steer the boat using the controls of the trolling motor. Such trolling motors often utilize a U-shaped frame that hangs on the transom and is then fixedly secured to the transom by a pair of clamping screws that are part of the frame. The clamps include head or handle portions that can be rotated by hand to tighten the clamps and secure the trolling motor to the transom. During use, these clamps can be inadvertently bumped or rotated to the point that the trolling motor is not completely secured to the transom. Another unfortunate reality concerning trolling motors is that the motors are vulnerable to theft since they are relatively small and light-weight and, as such, can be quickly and easily detached from the boat. A number of devices exist in the prior art for attempting to prevent or frustrate this type of inadvertent or intentional detachment. However, the prior art discloses devices or assemblies that comprise a number of separate parts or members, thus risking a lack of functionality if any one or more of those parts or members is separated from the others.

### SUMMARY OF THE INVENTION

In the view of this inventor, what is needed is a unitary, one-piece device or assembly for securely and inexpensively locking a trolling motor to the boat that it is attached to. The present invention provides such an assembly that, when used properly, helps to prevent inadvertent detachment or intentional theft of the trolling motor at all times during which the assembly is used. The present invention provides for a unique locking assembly having a number of components that form such a unitary device. The assembly includes a longitudinally extending base member that is attached via a hinge to a longitudinally extending cover member. The base member and the cover member, when rotated such that the cover member engages the base member, are functionally adapted to overlay the head portion of the clamping screws of the motor supports of the trolling motor thereby preventing rotation of them. The base member and the cover member each have a plurality of cooperating cut-outs defined in adjacent side-walls that allow the shaft of each of the clamping screws to protrude through the cut-outs. In that way, the base member and the cover member may be “clamped” down over the head portions of the clamping screws. The base member and the cover member also include a cooperating catch and cylinder lock with a rotatable latch, respectively, whereby the base member and the cover member may be locked together to secure the head portions of the clamping screws between them. The foregoing and other features of the assembly of the present invention will be apparent from the detailed description that follows.

### BRIEF DESCRIPTION OF THE DRAWINGS

FIG. 1 is a front, top and left side perspective view of the trolling motor lock assembly of the present invention as it is used with a trolling motor that is mounted to a boat, the assembly shown in the attached or secured position.

FIG. 2 is a front, top and left side perspective view of the trolling motor lock assembly of the present invention as it is used with a trolling motor that is mounted to a boat, the assembly shown in the detached or removed position.

FIG. 3 is an enlarged front, top and left side perspective view of the lock assembly illustrated in FIGS. 1 and 2 and showing the assembly as it would be in the “locked” or “closed” position.

FIG. 4 is an enlarged rear, bottom and left side perspective view of the lock assembly shown in FIG. 3.

FIG. 5 is an enlarged rear, top and left side perspective view of the lock assembly shown in FIGS. 3 and 4 and showing the assembly in the “unlocked” or “open” position.

FIG. 6 is an exploded rear, bottom and left side perspective view of the assembly of the present invention.

### DETAILED DESCRIPTION OF THE INVENTION

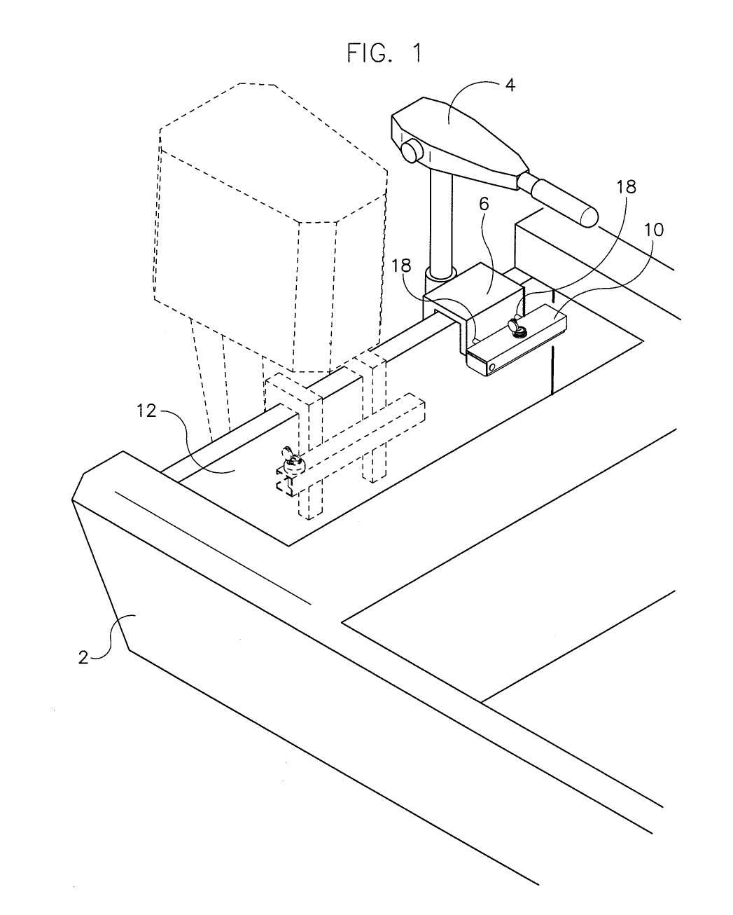

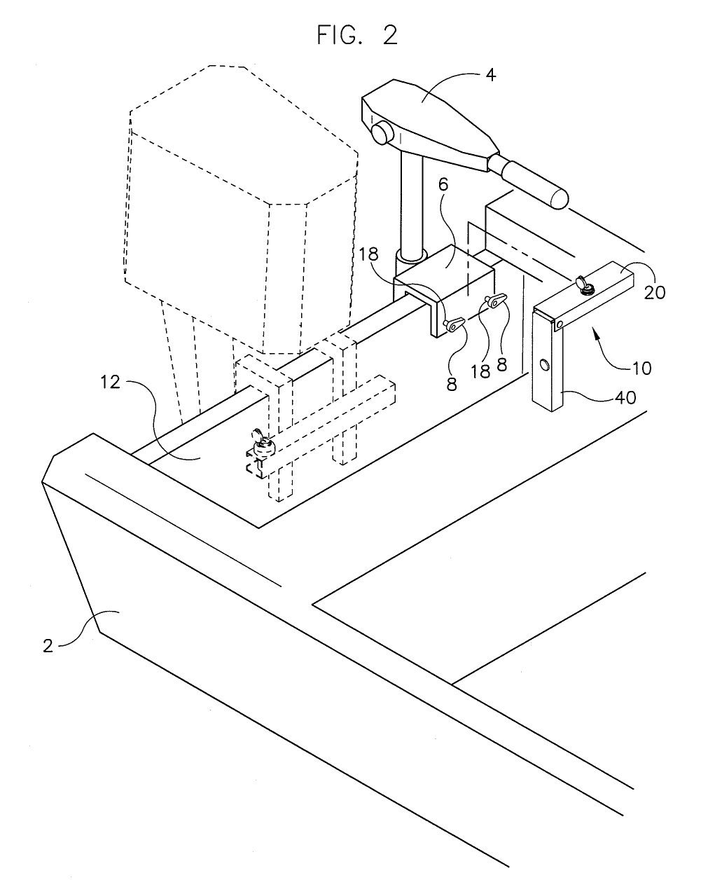

Referring now to the drawings in detail, wherein like numbered elements correspond to like elements throughout, FIG. 1 is a perspective view showing a preferred embodiment of the trolling motor lock assembly, generally identified 10, that is constructed in accordance with the present invention. An outboard motor is illustrated in phantom view in both FIGS. 1 and 2 to demonstrate how a trolling motor 4 might be used in conjunction with it. Such is not, however, required and is in no way a limitation of the present invention.

As shown, the trolling motor lock assembly 10 is shown as it would be attached to the head portions 8 of clamping screws 18 of the motor supports of the trolling motor 4 when the trolling motor 4 is secured to the transom 12 of a boat 2. See also FIG. 2 which illustrates the assembly 10 as it would appear when removed from the head portions 8 of the clamping screws 18. It is to be understood that the precise type of boat 2 or trolling motor 4 to which the assembly 10 of the present invention applies is not a limitation of this invention. Nor is the precise type of head portion 8 of the clamping screws 18 a limitation of the present invention. For example, the head portions 8 could be of the type that are generally lever shaped, as shown in FIG. 2. That is, each head portion 8 rotates about a central axis and has a “lever” portion that extends outwardly from that central axis to provide a force moment or torque to the head portion 8 for tightening or un-tightening the clamping screws 18 relative to the motor supports 6, which are understood to include a drive screw threaded portion and some sort of “seat” or pad (not shown). Rotation of the head portion 8 rotates the clamping screw 18 in a direction that drives the seat or pad towards or away from the transom 12 such that the head portion 8 effectively “clamps” the trolling motor 4 to the transom 12. The important aspect of the assembly 10 is that it prevents access to the head portion 8 of the clamping screws 18 to prevent their rotation when the assembly 10 is properly secured and locked in place.

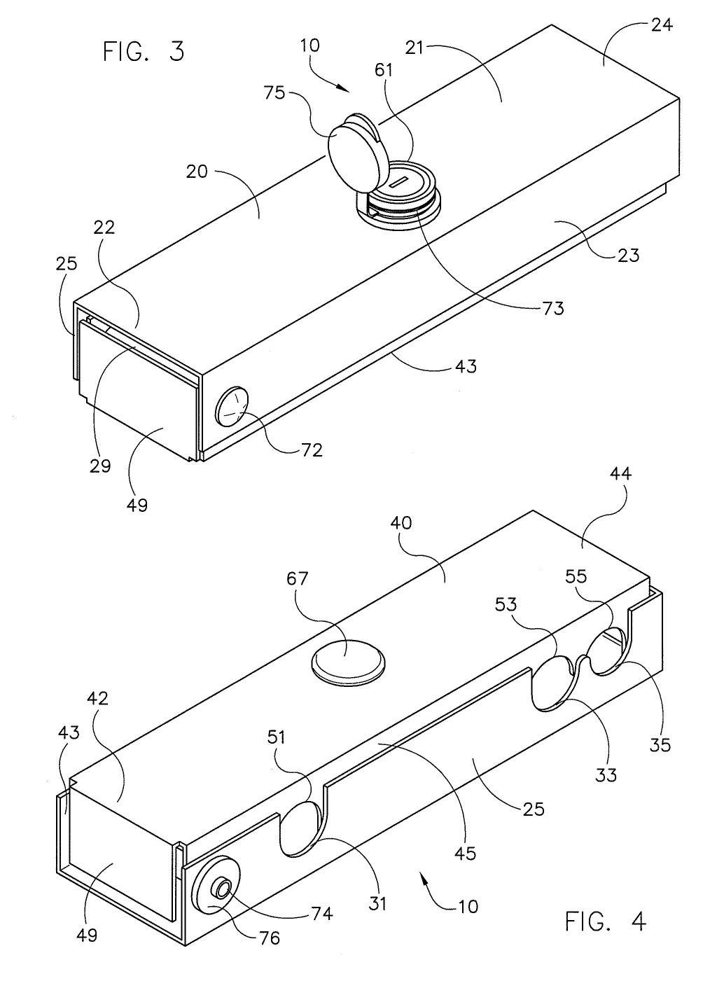

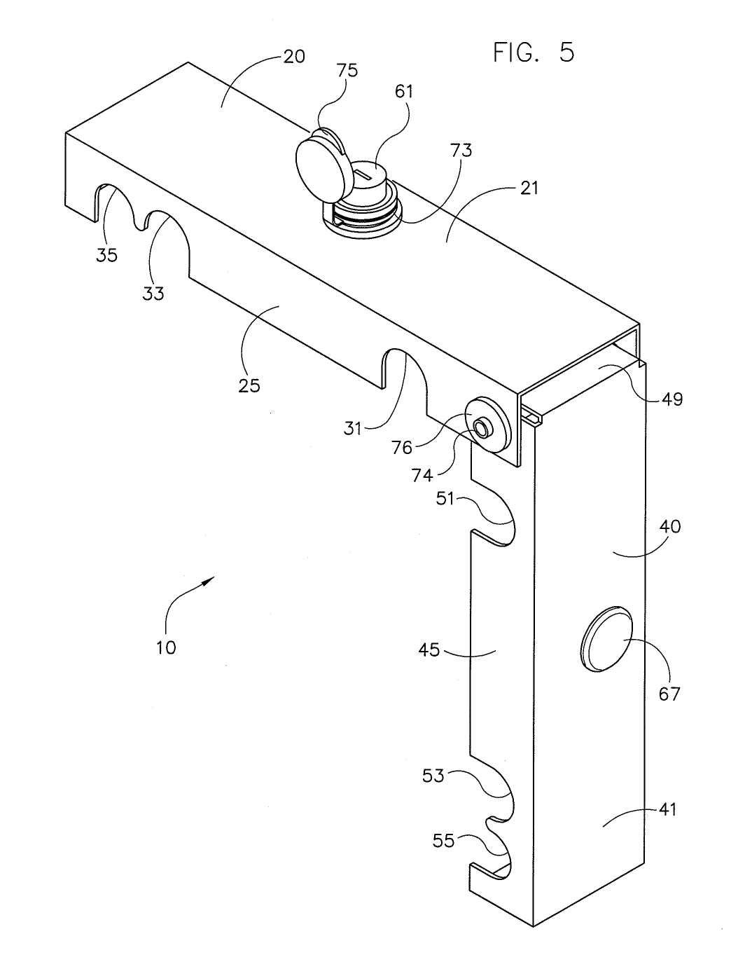

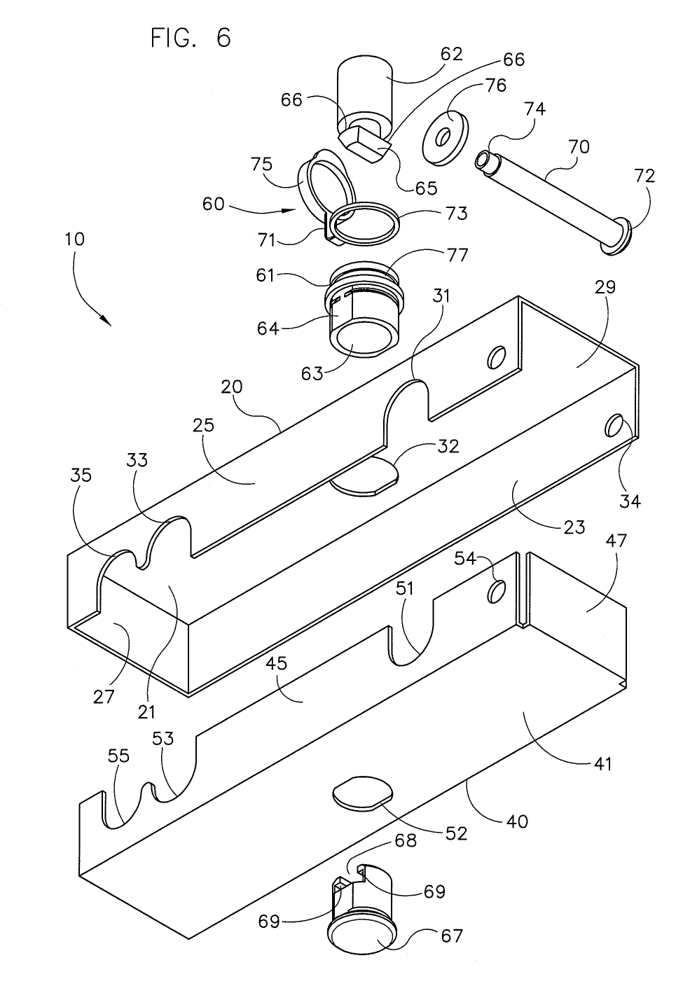

Referring now to FIG. 3, an enlarged rear view of the assembly 10 of the present invention is illustrated. This view illustrates the assembly 10 shown as it would be when detached from the boat 2 and as it would be when in the “closed” or “locked” position. FIG. 4 illustrates the assembly 10 as it would be when simply flipped upside down from its up-right position shown in FIG. 3. As shown, the assembly 10 includes a longitudinally-extending and rectangular-profiled cover member 20 and a similarly shaped, but slightly smaller, base member 40. When placed together as shown in FIGS. 3 and 4, the cover member 20 and the base member 40 form a generally rectangular box-like structure. The precise shape is not a limitation of the present invention as long as the assembly 10 includes a base member 40 and a cover member 20 that are capable of forming a hollow structure that functions in the intended fashion as is disclosed and described herein. In the preferred embodiment, however, the cover member 20 has a first end 22 and a second end 24. Extending between the first end 22 and the second end 24 of the cover member 20 is a longitudinally-extending and substantially-planar top face 21, a longitudinally-extending and substantially-planar front face 23, and a longitudinally-extending and substantially-planar back face 25. A substantially-planar side or end face 27 extends downwardly at a generally right angle from the top face 21 at the second end 24 of the cover member 20. Disposed at the first end 22 of the cover member 20 is an opening 29, which opening 29 facilitates rotation of the base member 40 relative to the cover member 20. See also FIGS. 5 and 6. The base member 40 of the assembly 10 similarly includes a first end 42 and a second end 44. Extending between the first end 42 and the second end 44 of the base member 40 is a longitudinally-extending and substantially-planar bottom face 41, a longitudinally-extending and substantially-planar front face 43, and a longitudinally-extending and substantially-planar back face 45. The base member 40 also includes a pair of opposing and substantially-planar side faces 47, 49, the side faces 47, 49 extending upwardly at a generally right angle from the bottom face 41 of the base member 40.

Defined within the planar back face 25 of the cover member 20 are a number of downwardly-directed and generally arcuate-shaped cut-outs, 31, 33, 35. Similarly, a number of upwardly-directed and generally arcuate-shaped cut-outs 51, 53, 55 are defined within the planar back face 45 of the base member 40. It is to be understood that the exact shape of the cut-outs 31, 33, 35, 51, 53, 55 is not a limitation of the present invention. The arcuate shape is, however, preferred since it most closely resembles the round profile of the threaded shaft of the clamping screws 18 that are intended to pass through the downwardly-directed cut-outs 31, 33, 35 of the cover member 20 and through the upwardly-directed cut-outs 51, 53, 55 of the base member 40 when the cover member 20 overlays the base member 40, as shown in FIGS. 3 and 4. As shown, the first cut-out 31 of the cover member 20 is generally aligned with the first cut-out 51 of the base member 40, and so on, to form functionally cooperating openings for access to the interior of the assembly 10. It should also be understood that the spacing between adjacent cut-outs 31, 33, 35, 51, 53, 55 may be varied in dimension to accommodate different spacings between clamping screws 18 that might be available by different manufacturers of trolling motors 4 to which the assembly 10 may be applied. This provides added versatility to use of the assembly 10.

The top face 21 of the cover member 20 includes an aperture 32 defined within it. This aperture 32 is functionally adapted to receive a portion of a lock sub-assembly, generally identified 60, within it. Similarly, the bottom face 41 of the base member 40 includes an aperture 52 defined within it, this aperture 52 also being functionally adapted to receive a portion of the lock sub-assembly 60 within it. As alluded to earlier, the base member 40 is hingedly attached to the cover member 20. To accomplish this, the front face 23 of the cover member 20 includes an aperture 34 and the back face 25 of the cover member 20 includes an aperture 36. See FIG. 6. Similarly, front face 43 of the base member 40 includes an aperture 54 and the back face 45 of the base member 40 includes an aperture (not shown). When the base member 40 and the cover member 20 are positioned atop one another, the apertures 34, 36, 54 are co-linear. In this fashion, a pin 70 is insertable through the apertures 34, 36, 54. The pin 70 includes a head portion 72 and an end portion 74, the end portion 74 being adapted to receive a washer 76 and then being flared following assembly to prevent removal of the pin 70.

Referring specifically to FIG. 6, it will be seen that the lock sub-assembly 60, shown in an exploded view, includes a lock cylinder 62 that is slidingly receivable within an aperture 63 defined within a lock receiver 64. It is to be understood that the lock cylinder receiver 64 is secured to or otherwise attached to the top face 21 of the cover member 20. It is also to be understood that the aperture 63 defined within the lock cylinder receiver 64 extends fully through the top face 21 of the cover member 20 as well. In this fashion, the lock cylinder 62 is able to pass through and extend through the top face 21 of the cover member 20 as well. The lock cylinder 62 includes a key receiving end 61. The key receiving end 61 further includes a cap assembly 71 having a ring 73 and a cap 75. The ring 73 of the cap assembly 71 is receivable within the ring-receiving groove 77 that is defined within the lock cylinder 64. It will be seen that the bottom most portion of the lock cylinder 62 includes a latch 65, the latch 65 including opposing and outwardly-extending latch shoulders 66. It is to be understood that a single latch shoulder 66 would still allow the latch 65 to function as intended. It will also be seen that the bottom face 41 of the base member 40 includes a latch receiver 67 that is secured to or otherwise attached to it as well. The latch receiver 67 of the lock sub-assembly 60 has a slot 68 that is defined within it. The slot 68 includes opposing and outwardly-extending shoulders 69 as well, the shoulders 69 of the latch receiver 67 being functionally engageable with the shoulders 66 of the latch 65, such engagement preventing upward movement of the lock cylinder 62 and the cover member 20 relative to the latch receiver 67 and the base member 40 when the assembly 10 is used as intended. Here again, a single shoulder 69 defined within the slot 68 of the latch receiver 67 would allow the latch receiver 67 to function as intended, the single shoulder 69 being functionally engageable with one of the latch shoulders 66 of the latch 65.

It is to be understood that the base member 40 and the cover member 20 are, in the preferred embodiment, each made of a single piece of stamped or bent sheet metal material. However, such is not a limitation of the present invention. It is also to be understood that the interior area of the assembly 10, the portion between the base member 40 and the cover member 20 when those members are in the “closed” of “locked” position, may include a resilient cushioning material such as foam rubber to prevent movement of the assembly 10 about the head portions 8 of the clamping screws and to prevent abrasion of those parts. Such is not, however, a limitation of the present invention.

In application, and assuming that the user has properly and suitably tightened the head portions 8 of the clamping screws 18, the user then positions the unitary trolling motor lock assembly 10 of the present invention immediately below the head portions 8 of the clamping screws 18. The assembly 10 would be in an L-shaped configuration with the base member 40 being generally horizontal and the cover member 20 being generally vertical, those two members 20, 40 always being connected to one another by virtue of the pin 70. Alternatively, and as shown in FIG. 2, the assembly 10 could be in an L-shaped configuration with the base member 40 being generally vertical and the cover member 20 being generally horizontal. Either presentation is acceptable and may be chosen by the user. What is important is that the relative distance between and position of the head portions 8 of the clamping screws 18 from one another will determine which of the cut-outs 31, 33, 35, 51, 53, 55 will be aligned with the clamping screws 18. The cut-outs 31, 51 closest to the pin 70 will always be used. Then, if the clamping screws 18 are located closer to one another, then the cut-outs 33, 53 that are next closest to the first cut-outs 31, 51, or the second cut-outs 33, 53, will be used. If the clamping screws 18 are located further away, then the cut-outs 35, 55 furthest from the first cut-outs 31, 51, or the third cut-outs 35, 55, will be used. The user then urges the cover member 20 downwardly over the base member 40. Also at this time, the latch 65 of the integral lock sub-assembly 60 will be lowered into and pass between the slot 68 of the latch receiver 67. A key (not shown) placed within the key-receiving end 61 of the lock sub-assembly 60 is then used to rotate the latch 65 such that the latch shoulders 66 engage the shoulders 69 of the latch receiver 67 to effectively lock the assembly 10 in that position. To remove the assembly 10 from head portions 8 of the trolling motor clamping screws 18, the reverse of this above-described process is all that is required.

Additional advantages and modifications will readily occur to those skilled in the art. Therefore, the invention in its broader aspects is not limited to the specific details disclosed and described herein. Accordingly, various modifications may be made without departing from the spirit or scope of the general inventive concept.

What is claimed is:

1. A trolling motor lock assembly (10) for use with a boat (2) and trolling motor (4), said trolling motor (4) including a motor support (6) and clamping screws (18), the clamping screws (18) each having a head portion (8) for securing the trolling motor (4) to the transom (12) of the boat (2), comprising:
a base member (40),
a cover member (20), said cover member (20) being hingedly secured to the base member (40) and further being adaptable to overlay the base member (40) to form a box-like structure for capturing the head portions (8) of the clamping screws (18) therewithin, and
a lock sub-assembly (60), said lock sub-assembly (60) having a latch (65) and a latch receiver (67), the latch (65) being capable of selective engagement with the latch receiver (67),
wherein the latch (65) is secured to the cover member (20) and the latch receiver (67) is secured to the base member (40) and
wherein the base member (40) and the cover member (20) are locked together when the latch (65) is selectively engaged with the latch receiver (67).

2. The lock assembly (10) of claim 1 wherein the base member (40) includes a bottom face portion (41) and the latch receiver (67) is secured to the bottom face portion (41) of the base member (40) and wherein the cover member (20) includes a top face portion (21) and the latch (65) is part of a lock cylinder (62) that is secured to the top face portion (21) of the cover member (20).

3. The lock assembly (10) of claim 2 wherein base member (40) includes a back face portion (45) having a plurality of upwardly-directed cut-outs (51, 53, 55) and wherein the cover member (20) includes a back face portion (25) having a plurality of downwardly-directed cut-outs (31, 33, 35).

4. The lock assembly (10) of claim 3 wherein the cut-outs (51, 53, 55) of the base member (40) are cooperatively aligned with the cut-outs (31, 33, 35) of the cover member (20) such that a portion of a clamping screw (18) may pass through them when the cover member (20) and the base member (40) are in a “closed” position and wherein the head portions (8) of the clamping screws (18) are captured between them.

5. The lock assembly (10) of claim 4 wherein the latch (65) includes at least one latch shoulder (66) and wherein the latch receiver (67) includes a slot (68) having at least one shoulder (69) defined within it, the latch shoulders (66, 69) being lockingly engageable.

6. The lock assembly (10) of claim 5 wherein the cover member (20) is hingedly attached to the base member (40) by means of a pin (70), the pin (70) including a head (72) and an end (74) that can be flared, the flared end (74) being retained by a washer (76).

7. A trolling motor lock assembly (10) for use with a trolling motor (4), said trolling motor (4) including a motor support (6) and clamping screws (18) for securing the trolling motor (4) to the transom (12) of a boat (2), each clamping screw (18) including a head portion (8) for tightening or un-tightening the clamping screw (18) to the boat transom (12) comprising:
a base member (40),
a cover member (20), said cover member (20) being hingedly secured to the base member (40) and further being adapted to overlay the base member (40) to form a structure for capturing the head portions (8) of the clamping screws (18) therewithin, and
a latch (65), said latch (65) being secured to the cover member (20), and
a latch receiver (67), said latch receiver (67) being secured to the base member (40),
wherein the latch (65) is capable of selective engagement with the latch receiver (67), and
wherein the base member (40) and the cover member (20) are locked together when the latch (65) is selectively engaged with the latch receiver (67).

8. The lock assembly (10) of claim 7 wherein the base member (40) includes a bottom face portion (41) and the latch receiver (67) is secured to the bottom face portion (41) of the base member (40) and wherein the cover member (20) includes a top face portion (21) and the latch (65) is part of a lock cylinder (62) that is secured to the top face portion (21) of the cover member (20).

9. The lock assembly (10) of claim 8 wherein base member (40) includes a back face portion (45) having a plurality of upwardly-directed cut-outs (51, 53, 55) and wherein the cover member (20) includes a back face portion (25) having a plurality of downwardly-directed cut-outs (31, 33, 35).

10. The lock assembly (10) of claim 9 wherein the cut-outs (51, 53, 55) of the base member (40) are cooperatively aligned with the cut-outs (31, 33, 35) of the cover member (20) such that a portion of a clamping screw (18) may pass through them when the cover member (20) and the base member (40) are in a “closed” position and wherein the head portions (8) of the clamping screws (18) are captured between them.

11. The lock assembly (10) of claim 10 wherein the cut-outs (51, 53, 55) of the base member (40) are cooperatively aligned with the cut-outs (31, 33, 35) of the cover member (20) to accommodate clamping screws (18) that are spaced apart from one another and to accommodate trolling motors (4) of different manufacture.

12. The lock assembly (10) of claim 11 wherein the latch (65) includes at least one latch shoulder (66) and wherein the latch receiver (67) includes a slot (68) having at least one shoulder (69) defined within it, the latch shoulders (66, 69) being lockingly engageable.

13. The lock assembly (10) of claim 12 wherein the cover member (20) is hingedly attached to the base member (40) by means of a pin (70), the pin (70) including a head (72) and an end (74) that can be flared, the flared end (74) being retained by a washer (76).
